(19) United States
(12) Patent Application Publication
(10) Pub. No.: US 2024/0261888 A1
(43) Pub. Date: Aug. 8, 2024

(54) Welding Apparatus That Arranges Welding Heads For Performing Welding In Plurality Of Different Directions And Welding Method Thereof

(71) Applicant: G-TEKT CORPORATION, Saitama-shi, Saitama (JP)

(72) Inventor: Akira CHINO, Koka-shi, Shiga (JP)

(21) Appl. No.: 18/561,244

(22) PCT Filed: May 13, 2022
(86) PCT No.: PCT/JP2022/020151

§ 371 Date: Nov. 15, 2023

(30) Foreign Application Priority Data
May 17, 2021 (JP) 2021-083059

(51) Int. Cl. B23K 11/24; B23K 11/11; B23K 11/14; B23K 37/04

(52) U.S. Cl. CPC B23K 11/24; B23K 11/11; B23K 11/14; B23K 37/0452

(57) ABSTRACT

A welding apparatus includes a rotary table (13) configured to support a support body (12) extending in a vertical direction such that it rotates about an axis in a vertical direction. The welding apparatus includes welding machines (11) provided to project outward from the support body (12), in which welding heads for welding a work are arranged in a plurality of different directions. The welding machines (11) include different welding heads or welding component supply machines of different welding components in accordance with a type of welding. It is possible to provide a projection welding apparatus capable of increasing types of weldable welding components to three or more.

### TECHNICAL FIELD

The present invention relates to a projection welding apparatus that welds many types of welding components such as nuts and bolts to a work formed by a plate material by projection welding and a projection welding method, or a spot-welding apparatus that spot-welds many types of works having different plate thicknesses and a spot-welding method.

### BACKGROUND ART

Conventionally, there exists a welding apparatus for welding a welding component to a work by resistance welding as described in patent literature 1. The welding apparatus disclosed in patent literature 1 includes a welding head formed by an upper electrode and a lower electrode, and presses a nut (welding component) against a work placed on the lower electrode and welds these by projection welding. The nut is supplied to the welding position of the work by a nut feeder including a guide tube located near the welding head.

In this welding apparatus, the work is gripped by an articulated robot for work conveyance and guided onto the lower electrode.

### RELATED ART LITERATURE

### Non-Patent Literature

Patent Literature 1: Japanese Patent Laid-Open No. 6-344151

### DISCLOSURE OF INVENTION

### Problem to be Solved by the Invention

In the welding apparatus disclosed in patent literature 1, the types of weldable welding components are limited to two types at maximum. That is, since spaces where the guide tube can be arranged are limited to the left side and the right side of the welding head, only two types of welding components can be supplied at maximum. In addition, if the thickness or material of the plate material that is a work, or the size or shape of the welding component changes, the tip diameter of an electrode chip that is the tip of the lower electrode or the upper electrode needs to be changed. This requires an electrode exchange work and lowers the productivity.

Also, in the welding apparatus disclosed in patent literature 1, when performing welding while causing the articulated robot to hold the work, the posture of the articulated robot is limited because of the work shape or the welding position. This is because the guide tube of the nut feeder is located near the welding head, and the work needs to be moved close to the lower electrode while avoiding interference with the guide tube. Restrictions on the posture of the articulated robot means that to align the welding position of the work to the welding head, the operation of the articulated robot is complex, and the time required for alignment is long.

The problem that the posture of the articulated robot is restricted occurs likewise even in a welding apparatus that performs spot-welding. That is, if the work is large and has a complex shape, and there are a plurality of welding positions, the articulated robot may be unable to take a posture suitable for welding because of interference with the welding head.

It is a first object of the present invention to provide a projection welding apparatus capable of increasing the number of types of welding components weldable by one apparatus to three or more.

It is a second object of the present invention to provide a welding apparatus that, when positioning a work to a welding position by a work conveyance articulated robot, increases the degree of freedom of the posture of the articulated robot.

It is a third object of the present invention to provide a projection welding method capable of shortening the time to align the welding head of a welding machine to the welding position of a work.

### Means of Solution to the Problem

In order to achieve the objects, according to the present invention, there is provided a welding apparatus comprising a rotary table configured to support a support body formed to extend in a vertical direction such that the support body rotates about an axis in a vertical direction as a center, and a plurality of welding machines provided on the support body to project outward with respect to the support body as the center, in which welding heads for welding a work are arranged in a plurality of different directions, the welding machines including different welding heads or welding component supply machines of different welding components in accordance with a type of welding.

According to the present invention, there is provided a welding method for performing welding using a welding machine including a welding head that sandwiches a work and performs welding and arranged to rotate about an axis in a vertical direction as a center, and a work conveyance articulated robot configured to hold and convey the work in a state in which a posture can be changed, comprising a first step of conveying the work toward the welding machine by the work conveyance articulated robot, a second step of rotating the welding machine such that the welding head approaches the work, and a third step of performing welding for the work by the welding machine, wherein the first step and the second step are simultaneously executed such that the welding machine and the work conveyance articulated robot cooperatively operate.

### Effect of the Invention

In the welding apparatus according to the present invention, in a case of projection welding, many types of welding components can be used in one welding apparatus. For example, if four welding machines are provided, welding component supply machines are arranged on both the left and right sides of each welding machine, thereby using eight types of welding components. In a case of spot-welding, a plate material combination point of many types of plate thicknesses can be welded in one welding apparatus. For example, if there are at least two spot-welding machines in which the chip diameters of electrode chips that contact a work and energize are different, spot-welding can be performed for works having two types of plate thicknesses. That is, a thin plate material can be welded using a spot-welding machine including an electrode chip with a small chip diameter, and a thick plate material can be welded using a spot-welding machine including an electrode chip with a large chip diameter.

Also, according to the present invention, when avoiding interference between the work and the welding machine, the position of the welding machine is changed, thereby reducing the change of the posture of the work conveyance articulated robot.

Hence, according to the present invention, it is possible to provide a welding apparatus capable of increasing types of weldable welding components to three or more, and when positioning the work to the welding apparatus by the work conveyance articulated robot, increasing the degree of freedom of the posture of the articulated robot.

In the welding method according to the present invention, while the work held by the work conveyance articulated robot approaches the welding machine, the welding machine rotates and moves toward the work. For this reason, according to this welding method, the time for aligning the welding head of the welding machine to the welding position of the work can be shortened.

### BRIEF DESCRIPTION OF DRAWINGS

FIG. 1 is a perspective view of a welding apparatus according to the present invention;

FIG. 2 is a plan view of a welding portion;

FIG. 3 is a front view of the welding portion;

FIG. 4 is a block diagram showing the configuration of a control system;

FIG. 5 is a flowchart for explaining a welding method;

FIG. 6 is a timing chart showing the operations of a welding machine and a work conveyance articulated robot;

FIG. 7A is a plan view showing a state in which a welding component supply machine and a work interfere with each other;

FIG. 7B is a side view showing the state in which the welding component supply machine and the work interfere with each other;

FIG. 8 is a plan view showing a state in which the interference between the welding component supply machine and the work is eliminated;

FIG. 9 is a plan view showing a modification of the welding machine; and

FIG. 10 is a perspective view of a welding portion including a projection welding machine and a spot-welding machine.

### BEST MODE FOR CARRYING OUT THE INVENTION

### First Embodiment

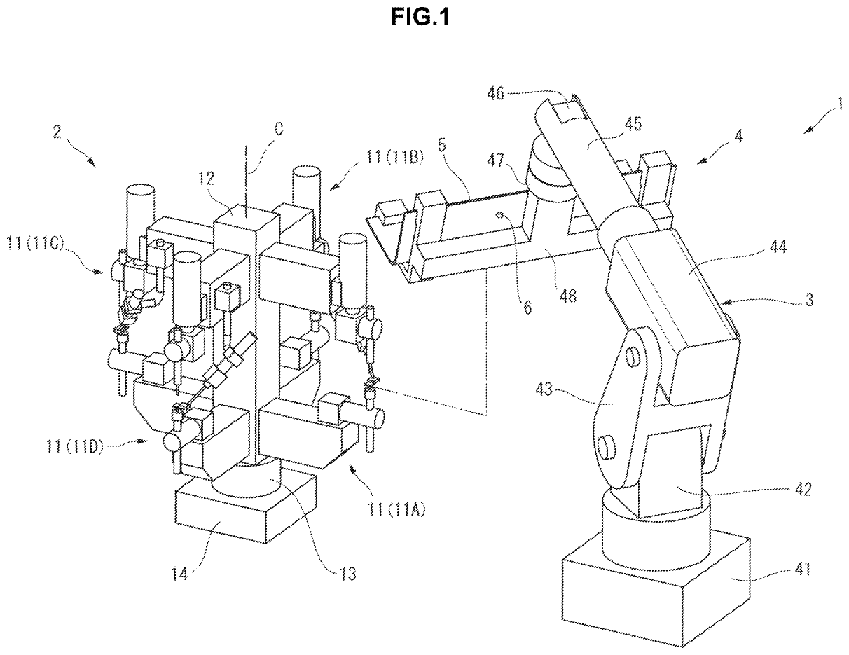

An embodiment of a projection welding apparatus and a projection welding method as a kind of welding according to the present invention will be described below in detail with reference to FIGS. 1 to 8. Note that this embodiment is an embodiment of a spot-welding apparatus and execution of a spot-welding method except a welding component supply machine and its associated components.

A projection welding apparatus 1 shown in FIG. 1 includes a welding unit 2 drawn on the left side of FIG. 1, and an articulated robot 3 (to be referred to as a work conveyance robot hereinafter) drawn on the right side. The work conveyance robot 3 holds and conveys a work 5 in a state in which its posture can be changed.

The work 5 is, for example, a large vehicle body component such as a tunnel portion of a floor panel. The work 5 shown in FIG. 1 is a half of the tunnel portion, and is formed by bending a steel sheet into an L-shaped cross section. Left and right components are connected to form a tunnel portion having a U-shaped cross section and opening to the lower side. To fasten a pipe fixing bracket or the like, a fastener that is a welding component including a nut and a bolt (not shown) is welded to the work 5. In the work 5 according to this embodiment, a through hole 6 is formed in a target welding portion to which the welding component is welded. The number of welding components is not limited to one for one work 5, and a plurality of welding components may exist.

The welding unit 2 includes a plurality of projection welding machines 11. The welding unit 2 according to this embodiment is provided with first to fourth projection welding machines 11A to 11D. The first to fourth projection welding machines 11A to 11D weld different types of welding components to the work 5. The first to fourth projection welding machines 11A to 11D are provided on one columnar support body 12 such that these project radially (outward) with respect to the support body 12 as the center. Hereafter, when indicating directions in the explanation of the projection welding machine 11, a direction of the projection welding machine 11 projecting from the support body 12 is defined as a front side, and a description will be made in a direction of the projection welding machine 11 viewed from the front side.

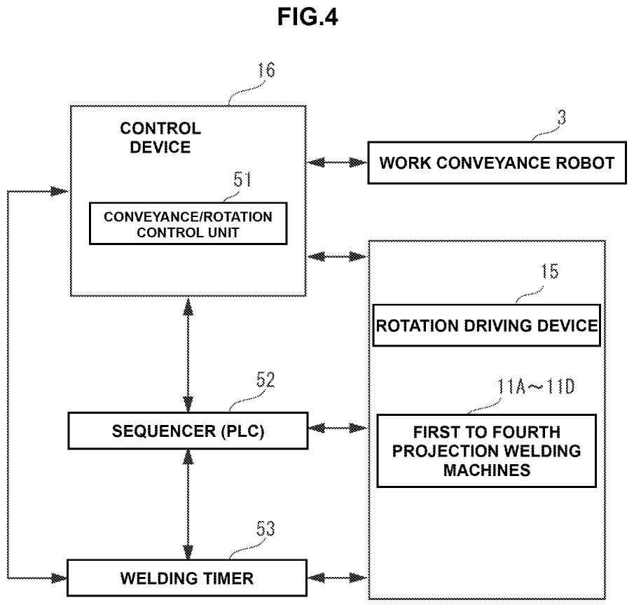

The support body 12 is formed to extend in the vertical direction, and is supported by a rotary table 13. The rotary table 13 is provided on a base 14 and supports the support body 12 such that it can rotate about an axis C in the vertical direction. Hence, the first to fourth projection welding machines 11A to 11D can rotate about the axis C. The rotary table 13 is provided with a rotation driving device 15 (see FIG. 4) that rotates the support body 12 about the axis C. The rotation driving device 15 can switch a form in which the support body 12 rotates clockwise when viewed from above and a form in which the support body 12 rotates counterclockwise when viewed from above. The support body 12 can be finely rotated by servo control. The operation of the rotation driving device 15 is controlled by a control device 16 (see FIG. 4) to be described later. The control device 16 will be described later.

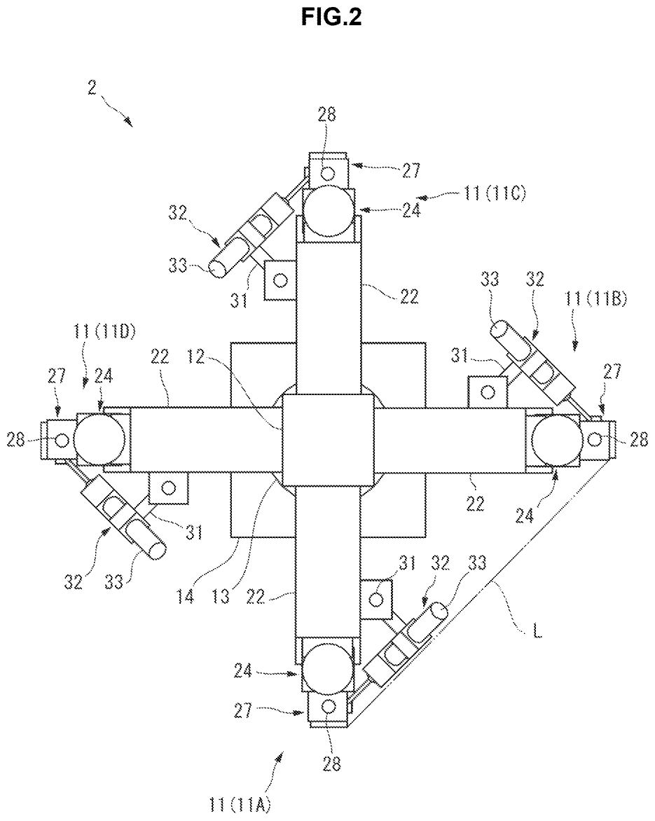

In this embodiment, as shown in FIG. 2, the four projection welding machines 11 (first to fourth projection welding machines 11A to 11D) are arranged in a cross shape with respect to the support body 12 as the center in a planar view. The projection welding machines 11 have the same structure. Note that the plurality of projection welding machines 11 need not always be identical, and projection welding machines of different specifications may be used. Here, of the four projection welding machines 11 (first to fourth projection welding machines 11A to 11D), one projection welding machine 11 (first projection welding machine 11A) will be described. For the remaining projection welding machines 11, the same reference numerals are used, and a description thereof will be omitted.

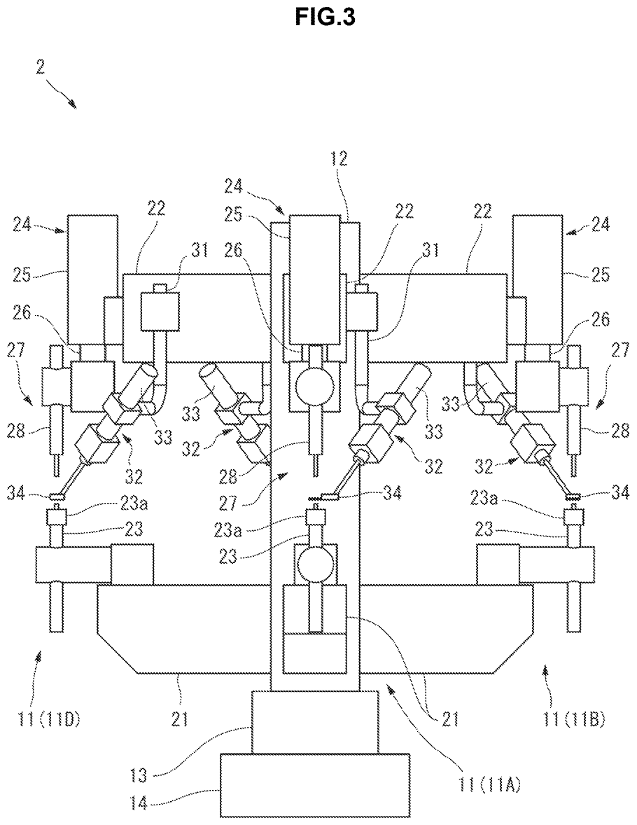

As shown in FIG. 3, the first projection welding machine 11A includes a lower support arm 21 attached to the lower portion of the support body 12, and an upper support arm 22 attached to the upper portion of the support body 12 such that it is located above the lower support arm 21.

The lower support arm 21 projects outward from the support body 12 in the horizontal direction. A lower electrode 23 is provided at the projecting side end portion of the lower support arm 21. An electrode main body 23a on which the work 5 is placed is provided at the upper end of the lower electrode 23. The electrode main body 23a forms an “electrode chip” in the present invention.

The electrode main body 23a that fits with a welding component is used. As welding components, different types of components such as a nut and a bolt and components of different sizes such as the screw diameters of nuts and bolts are used. For example, if a nut is used as the welding component, the electrode main body 23a for nut is attached to the lower electrode 23, and if a bolt is used as the welding component, the electrode main body 23a for bolt is attached to the lower electrode 23. The four projection welding machines 11 according to this embodiment are configured to use welding components of different types and sizes, that is, welding components of different types.

The upper support arm 22 projects outward from the support body 12 in the horizontal direction such that it is located immediately above the lower support arm 21. A pressurization unit 24 is provided at the projecting side end portion of the upper support arm 22.

The pressurization unit 24 includes an air cylinder 25 that extends in the vertical direction, and a piston rod 26 projecting downward from the lower end of the air cylinder 25. The piston rod 26 moves down when air is supplied to the upper portion of the air cylinder 25, and moves up when air is supplied to the lower portion of the air cylinder 25. The operation of the air cylinder 25 is controlled by the control device 16 to be described later.

An upper electrode 28 that forms a welding head 27 in cooperation with the above-described lower electrode 23 is attached to the lower end portion of the piston rod 26. The upper electrode 28 forms an “electrode chip” in the present invention. Projection welding is performed while sandwiching the work 5 and a welding component between the lower electrode 23 and the upper electrode 28 in the welding head 27. The upper electrode 28 is located immediately above the above-described lower electrode 23, and connected to a feeding device via a feeder cable (not shown). The feeding device is controlled by the control device 16 to be described later. The lower end portion of the upper electrode 28 presses the welding component in a step of moving down the piston rod 26.

A welding component supply machine 32 is attached to one side portion of the upper support arm 22 via a support bracket 31.

The welding component supply machines 32 are provided for the first to fourth projection welding machines 11A to 11D, respectively, and supply different types of welding components to the lower electrodes 23 of the first to fourth projection welding machines 11A to 11D. The welding component supply machine 32 according to this embodiment includes a component holder 34 that advances or retreats when driven by an air cylinder 33. The welding component is supplied from a supply hose (not shown) to the component holder 34 at the retreat position and transferred to the electrode main body 23a in a state in which the component holder 34 advances near the top of the lower electrode 23.

The welding component supply machine 32 is arranged in at least one of one rotation direction and the other rotation direction of the rotary table 13 in each of the first to fourth projection welding machines 11A to 11D. As shown in FIG. 3, the welding component supply machine 32 according to this embodiment is arranged on the right side of the projection welding machine 11 viewed from the front side (the direction from the side of the welding head 27 toward the axis C of the rotary table 13). That is, the welding component supply machine 32 is arranged in one of the rotation directions of the rotary table 13 with respect to the projection welding machine 11.

In addition, the welding component supply machine 32 tilts in a predetermined direction. The direction of the tilt of the welding component supply machine 32 is a direction tilting upward to the right when the projection welding machine 11 is viewed from the front side, as shown in FIG. 3, and is a direction toward the welding head 27 of the adjacent projection welding machine 11 located on the right side in a planar view, as shown in FIG. 2. More specifically, in the planar view shown in FIG. 2, the welding component supply machine 32 tilts in the horizontal direction along a virtual line L that connects the distal ends of two projection welding machines 11 adjacent to each other.

The work conveyance robot 3 is a 6-axis articulated robot, and includes a base 41, and first to sixth rotating portions 42 to 47, as shown in FIG. 1. The first rotating portion 42 is supported by the base 41 to rotate about an axis in the vertical direction. The second rotating portion 43 is supported by the first rotating portion 42 to rotate about an axis in the horizontal direction. The third rotating portion 44 is supported by the second rotating portion 43 to rotate about an axis in the horizontal direction. The fourth rotating portion 45 is supported by the third rotating portion 44 to rotate about an axis in a direction in which the third rotating portion 44 extends. The fifth rotating portion 46 is supported by the fourth rotating portion 45 to rotate about an axis orthogonal to the rotation axis of the fourth rotating portion 45. The sixth rotating portion 47 is supported by the fifth rotating portion 46 to rotate about an axis orthogonal to the rotation axis of the fifth rotating portion 46. The sixth rotating portion 47 is provided with a clamp (work fixing jig) 48 that grips the work 5. The operation of the work conveyance robot 3 is controlled by the control device 16 to be described later.

As shown in FIG. 4, the control device 16 includes a conveyance/rotation control unit 51, and the rotation driving device 15, a sequencer 52, and a welding timer 53 are connected.

In the step from the load of the work 5 to the placement of the work 5 on the lower electrode 23, the conveyance/rotation control unit 51 controls the operation of the work conveyance robot 3 and the operation of the rotary table 13 by servo control such that these cooperate. When controlling the work conveyance robot 3, the conveyance/rotation control unit 51 controls the work conveyance robot 3 such that the work 5 is conveyed from the apparatus of the preprocess to the welding unit 2.

Also, when controlling the rotary table 13, the conveyance/rotation control unit 51 controls the operation of the rotary table 13 such that, of the first to fourth projection welding machines 11A to 11D, the projection welding machine 11 capable of welding the next welding component approaches the work conveyance robot 3. Then, when placing the target welding portion of the work 5 on the lower electrode 23, the conveyance/rotation control unit 51 of the control device 16 controls the rotary table 13 and the work conveyance robot 3 to make these simultaneously operate and cooperate with each other such that the target welding portion of the work 5 and the welding head 27 of the projection welding machine 11 approach each other.

The sequencer 52 selects, of the first to fourth projection welding machines 11A to 11D, the projection welding machine 11 for supplying the welding component to be welded next, and controls the operation of the projection welding machine 11.

In addition, the sequencer 52 controls the operation of the welding component supply machine 32 (air cylinder 33) such that the welding component is supplied to the lower electrode 23, and controls the operation of the pressurization unit 24 and a welding current such that the upper electrode 28 lowers, and projection welding is performed after the supply of the component.

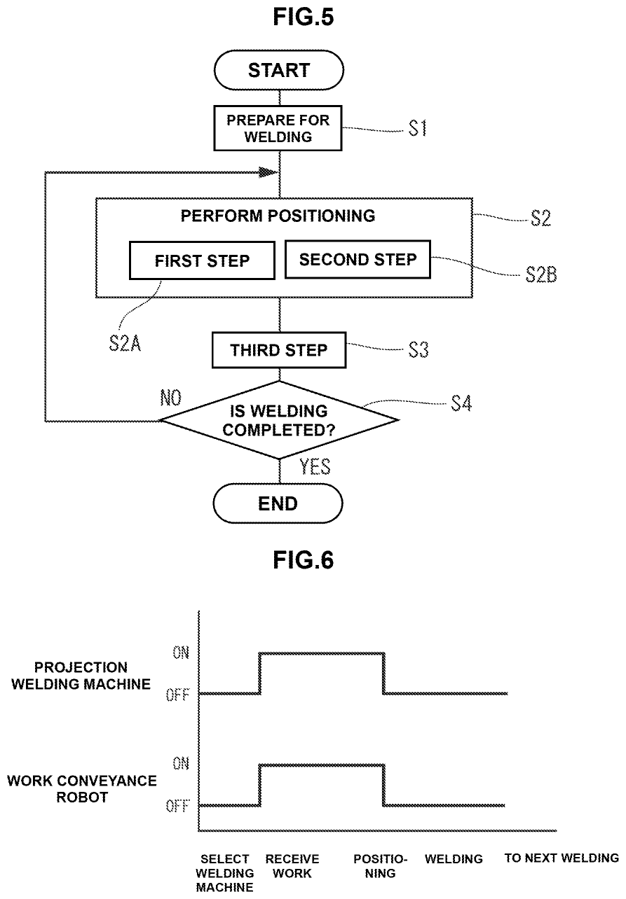

An example of a method of welding a welding component to the work 5 using the above-described projection welding apparatus 1 will be described with reference to the flowchart of FIG. 5 and the timing chart of FIG. 6.

When executing projection welding, first, the control device 16 prepares for welding (step S1). In step S1 of performing the welding preparation, the control device 16 selects the projection welding machine 11 capable of welding a welding component of a first type. The control device 16 then controls the operation of the rotary table 13 to rotate the projection welding machine 11 such that the projection welding machine 11 approaches the work conveyance robot 3. The rotation direction at this time is the direction in which the moving distance is as short as possible.

Also, in step S1 of performing the welding preparation, the control device 16 controls the operation of the work conveyance robot 3 to receive the work 5 from the apparatus of the preprocess.

After that, the control device 16 positions the work 5 and the lower electrode 23 (step S2). This positioning is performed while making the target welding portion of the work 5 match the position of the lower electrode 23, and placing the work 5 on the lower electrode 23. In step S2 of performing positioning, a first step S2A and a second step S2B progress simultaneously.

In the first step S2A, the work conveyance robot 3 conveys the work 5 received from the apparatus of the preprocess to the projection welding machine 11.

In the second step S2B, the rotary table 13 operates to rotate the projection welding machine 11 such that the welding head 27 of the projection welding machine 11 capable of welding the welding component of the first type to be welded approaches the work 5.

The first step S2A and the second step S2B are simultaneously executed such that the projection welding machine 11 and the work conveyance robot 3 cooperatively operate. At this time, for example, the rotary table 13 and the work conveyance robot 3 operate such that the time until the target welding portion of the work 5 matches the position of the lower electrode 23 is shortest.

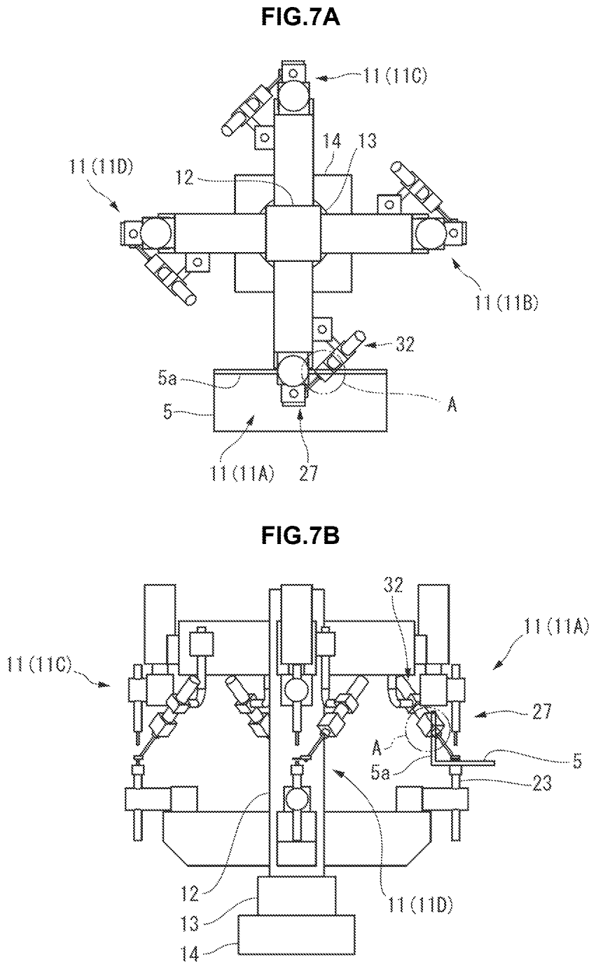

In step S2 of performing positioning, as shown in FIGS. 7A and 7B, if the projection welding machine 11 rotates such that the welding head 27 is closest to the work conveyance robot 3, a part of the work 5 may interfere with, for example, the welding component supply machine 32 of the projection welding machine 11. In this case, the work conveyance robot 3 and the rotary table 13 operate to avoid interference. FIG. 7A is a plan view, and FIG. 7B is a side view. FIGS. 7A and 7B show that a vertical wall 5a of the work 5 extending in the vertical direction interferes with the welding component supply machine 32. In this embodiment, the vertical wall 5a is a “convex portion” in the present invention. In FIGS. 7A and 7B, a portion surrounded by a circle is an interference portion A.

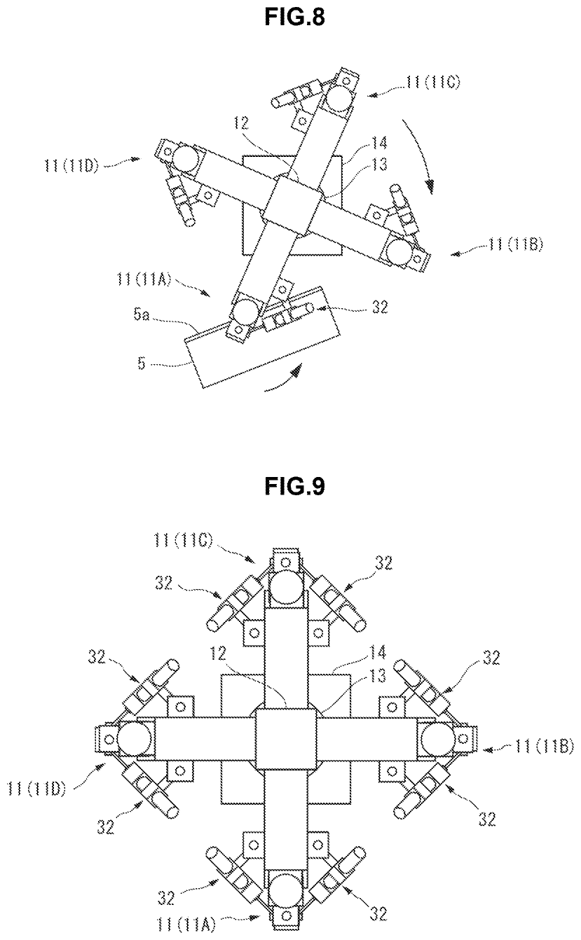

If the work 5 and the welding component supply machine 32 interfere with each other, as shown in FIG. 8, the projection welding machine 11 rotates clockwise in FIG. 8 such that the welding component supply machine 32 is parallel to the vertical wall 5a in the planar view, and the work conveyance robot 3 changes the angle of the work 5, thereby avoiding interference between the vertical wall 5a and the welding component supply machine 32. That is, when avoiding interference between the work 5 and the welding component supply machine 32, the position of the projection welding machine 11 is changed by rotating it, thereby reducing the change of the posture of the work conveyance robot 3.

If the positioning of the target welding portion of the work 5 and the lower electrode 23 is ended, third step S3 is executed in a state in which the rotary table 13 and the work conveyance robot 3 are stopped. In the third step S3, the control device 16 controls the operation of the projection welding machine 11 such that the welding component is welded to the target welding portion of the work 5. That is, the welding component is supplied to the target welding portion by the welding component supply machine 32, the upper electrode 28 lowers, and projection welding is performed.

After the welding is ended, the control device 16 determines whether the welding of the welding component to the work 5 is completed (step S4). To weld a welding component of a second type, the process returns to step S2 of performing positioning to repeat the above-described operation. For example, the welding component of the first type is welded by the first projection welding machine 11A, the support body 12 rotates clockwise after that, and the welding component of the second type can be welded by the second projection welding machine 11B.

In the thus configured projection welding apparatus 1, welding components of types corresponding to the number of projection welding machines 11 can be used. In this embodiment, four projection welding machines 11 (first to fourth projection welding machines 11A to 11D) are provided. In a case where two projection welding machines 11 are provided, if the welding component supply machine 32 is arranged on each of the left and right sides of each projection welding machine 11, four types of welding components can be used. For example, as shown in FIG. 9, the welding component supply machine 32 is arranged on each of the left and right sides of one projection welding machine 11, thereby handling a total of eight types of welding components.

Also, according to this embodiment, when avoiding interference between the work 5 and the projection welding machine 11, the position of the projection welding machine 11 is changed, thereby reducing the change of the posture of the work conveyance robot 3.

Hence, according to this embodiment, it is possible to provide a projection welding apparatus that can increase the number of types of weldable welding components to two or more and increase the degree of freedom of the posture of the work conveyance robot when positioning the work to the welding apparatus by the robot.

In the projection welding method according to this embodiment, while the work 5 approaches the projection welding machine 11, the projection welding machine 11 moves toward the work 5. For this reason, according to this projection welding method, the time for aligning the welding head 27 of the projection welding machine 11 to the welding position of the work 5 can be shortened as compared to positioning the work to the welding position only by the work conveyance robot.

The projection welding apparatus 1 according to this embodiment includes the work conveyance robot 3 (articulated robot) that conveys the work 5 to which a welding component is welded and guides it to the welding head 27, and the control device 16 that controls the operation of the rotary table 13 and the operation of the work conveyance robot 3.

The control device 16 controls the rotary table 13 and the work conveyance robot 3 to make these simultaneously operate and cooperate with each other such that the target welding portion of the work 5 and the welding head 27 of the projection welding machine 11 approach each other. Hence, since the interference between the work 5 and the welding head or the welding component supply machine 32 can easily be avoided, the degree of freedom of the shape of the work 5 increases.

In this embodiment, when welding a plurality of types of welding components to each work 5 or one work 5, the projection welding machine 11 is rotated in the rotation direction in which the time required for the welding head 27 to approach the target welding portion of the work 5 is shortest, thereby accelerating the approach of the welding head 27 and improving the welding speed.

The welding component supply machine 32 according to this embodiment tilts in the horizontal direction along the virtual line L that connects the distal ends of the two projection welding machines 11 adjacent to each other when viewed from above. For this reason, even if the welding component supply machines 32 are provided on both sides of one projection welding machine 11, the occupied space does not expand due to the welding component supply machines 32, and a compact projection welding apparatus can be implemented.

### Second Embodiment

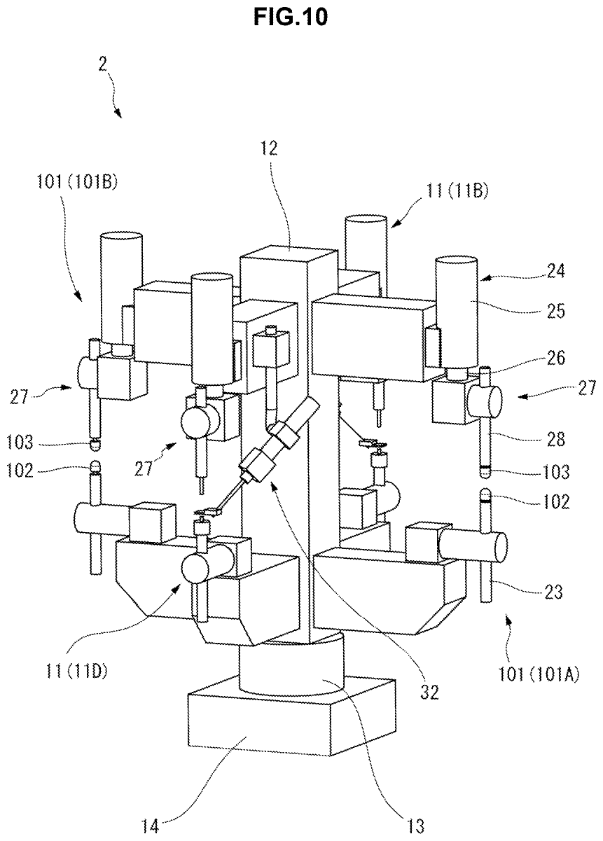

In the above-described embodiment, a form in a case where welding is projection welding has been described. If welding is spot-welding, a welding unit 2 can be formed using a spot-welding machine 101 in place of a projection welding machine 11, as shown in FIG. 10. The same reference numerals as in FIGS. 1 to 9 denote the same or similar members in FIG. 10, and a detailed description thereof will be omitted.

The welding unit 2 shown in FIG. 10 includes first and second spot-welding machines 101A and 101B in place of first and third projection welding machines 11A and 11C in a case where the form the first embodiment is employed. The first and second spot-welding machines 101A and 101B are arranged on one support body 12 such that these are distributed to one and the other sides of the support body 12. Note that as shown in FIG. 10, if a plurality of projection welding machines and a plurality of spot-welding machines coexist in one welding unit 2, the plurality of projection welding machines can be arranged at positions adjacent to each other, and the plurality of spot-welding machines can be arranged at positions adjacent to each other. Also, the welding unit 2 can also be formed using only spot-welding machines, although not illustrated.

A welding head 27 of each of the first and second spot-welding machines 101A and 101B includes a lower electrode chip 102 and an upper electrode chip 103, which contact a work and energize. The outer diameter of the lower electrode chip 102 and the upper electrode chip 103 changes between the spot-welding machines. The outer diameter of the lower electrode chip 102 and the upper electrode chip 103 provided on the welding head 27 of the first spot-welding machine 101A is larger than the outer diameter of the lower electrode chip 102 and the upper electrode chip 103 provided on the welding head 27 of the second spot-welding machine 101B. Basically, identical welding heads are used for the welding head 27 of the first spot-welding machine 101A and the welding head 27 of the second spot-welding machine 101B. In general, the welding head of the spot-welding machine may be changed to an appropriate one if a high pressurization force is necessary. For example, if the welding current is large, the welding head is large, and if the material of the work is hard, the welding head is large.

The larger the outer diameter of the lower electrode chip 102 and the upper electrode chip 103 is, the larger the current that can be flowed is, and the larger the plate thickness for which spot-welding is possible is.

In the welding unit 2, when welding a plurality of plates of different thicknesses in a superposed state to one work 5 by spot-welding, a welding machine in which the outer diameter of the lower electrode chip 102 and the upper electrode chip 103 corresponds to the thickness of the spot-welding portion is used. That is, if there is a spot-welding portion where the total plate thickness of a plurality of works 5 superposed is different, the welding unit 2 performs spot-welding using, of the first and second spot-welding machines 101A and 101B, a welding machine suitable for the total plate thickness.

As an example of such welding, for example, there is a case where a plurality of reinforcing plates (patches) of different thicknesses are welded, by spot-welding, to the work 5 that is a part of a floor panel (not shown). In this case, the total plate thickness is not constant in all a plurality of target welding portions, and a target welding portion where the total plate thickness is large and a target welding portion where the total plate thickness is small are generated. When performing such spot-welding, a control device 16 welds a target welding portion with a large total plate thickness in the work 5 using, for example, the first spot-welding machine 101A, and after the welding, rotates the support body 12, for example, clockwise when viewed from above. At this time, the control device 16 moves a work conveyance robot 3 simultaneously, and welds a target welding portion with a small total plate thickness in the work 5 using, for example, the second spot-welding machine 101B. In this case, the first spot-welding machine 101A includes the lower electrode chip 102 and the upper electrode chip 103, which make the nugget diameter of the welding portion large, and the second spot-welding machine 101B includes the lower electrode chip 102 and the upper electrode chip 103, which make the nugget diameter of the welding portion small.

Also, when performing spot-welding using the first and second spot-welding machines 101A and 101B, the welding head 27 in which the diameter of the distal ends of the lower electrode chip 102 and the upper electrode chip 103 is small and the welding head 27 in which the diameter of the distal ends of the lower electrode chip 102 and the upper electrode chip 103 is large can selectively be used in accordance with at least one of the area of the space of the welding point and the total plate thickness of the target welding portion of the work 5.

In this embodiment, if the large work 5 includes a plurality of spot-welding portions, the first and second spot-welding machines 101A and 101B are rotated, and the work conveyance robot 3 is moved, thereby accelerating the approach between the welding machine and the work 5 and improving the welding speed.

### EXPLANATION OF THE REFERENCE NUMERALS AND SIGNS

1 . . . projection welding apparatus, 3 . . . work conveyance robot (articulated robot), 5 . . . work, 11A . . . first projection welding machine, 11B . . . second projection welding machine, 11C . . . third projection welding machine, 11D . . . fourth projection welding machine, 12 . . . support body, 13 . . . rotary table, 15 . . . control device, 27 . . . welding head, 32 . . . welding component supply machine, 101A . . . first spot-welding machine, 101B . . . second spot-welding machine, L . . . virtual line, S2A . . . first step, S2B . . . second step, S3 . . . third step.

1. A welding apparatus comprising:
a rotary table rotatable about an axis in a first direction,
a support body formed to extend in the first direction and provided on the rotary table such that the support body rotates about the axis in the first direction as a center; and
a plurality of welding machines provided on the support body to project along directions orthogonal to the first direction, each of the plurality of welding machines including a welding head for welding a work and a welding component supply machine,
wherein, among the plurality of welding machines, at least one of the welding head and the welding component supply machine of at least one of the plurality of welding machines is for different type of welding from the others.

2. The welding apparatus according to claim 1, wherein
the at least one of the plurality of welding machines includes a welding head for spot-welding.

3. The welding apparatus according to claim 1, wherein
the at least one of the plurality of welding machines includes a welding component supply machine for projection welding arranged in one of rotation directions of the rotary table.

4. The welding apparatus according to claim 1, further comprising:
a work conveyance robot configured to convey the work and guide the work to the welding head; and
a control device configured to control an operation of the rotary table and an operation of the work conveyance robot,
wherein the control device controls the rotary table and the work conveyance robot to make the rotary table and the work conveyance robot simultaneously operate and cooperate with each other such that a target welding portion of the work and the welding head of each of the plurality of welding machines approach each other.

5. The welding apparatus according to claim 1, wherein
each of the plurality of welding machines is a projection welding machine, and
the welding component supply machine of each of the plurality of welding machines tilts in a horizontal direction along a virtual line that connects distal ends of the two projection welding machines adjacent to each other when viewed from above.

6. The welding apparatus according to claim 1, wherein
the plurality of welding machines include four welding machines arranged in a cross shape with respect to the support body as the center in a planar view.

7. A welding method for performing welding using
a welding machine including a welding head that sandwiches a work and performs welding and arranged to rotate about an axis in a first direction as a center, and
an articulated robot configured to hold and convey the work while being able to change its posture, comprising:
conveying the work toward the welding machine by the articulated robot;
rotating the welding machine such that the welding head approaches the work; and
performing welding for the work by the welding machine,
wherein the work is conveyed while the welding machine rotate such that the welding machine and the articulated robot cooperatively operate.

8. The welding apparatus according to claim 1, wherein
each of the welding heads includes an electrode chip that contacts and energizes the work,
a diameter of a distal end of the electrode chip of at least one of the welding heads is smaller than a diameter of a distal end of the electrode chip of another one of the welding heads, and
the plurality of welding machines are configured to selectively use the at least one of the welding heads with the electrode chip of the diameter which is smaller than the others and the other welding head in accordance with at least one of an area of a space of a welding point and a thickness of a target welding portion of the work.

9. The welding apparatus according to claim 4, wherein
the control device controls the operation of the rotary table and the operation of the work conveyance robot, such that, when the work has a convex portion and includes a plurality of target welding portions, the welding head that performs welding for the plurality of target welding portions rotates, and the work conveyance robot moves, thereby accelerating approach between the plurality of target welding portions of the work and the welding head and preventing interference between the convex portion of the work and the welding head.

10. The welding apparatus according to claim 1, wherein
when welding a plurality of types of components to the work, the welding machine rotates in a rotation direction in which a time required for the welding head to approach a target welding portion of the work is shortest.
